(19) United States
(12) Patent Application Publication
(10) Pub. No.: US 2004/0080152 A1
(43) Pub. Date: Apr. 29, 2004

(54) System and method for obtaining a gift wish list

(76) Inventor: Pamela Houston, Overland Park, KS (US)

Correspondence Address: DAVID E. HERRON 11, P. O. BOX 2778, 1100 Main Street, Kansas City, KS, 66110, US

(21) Appl. No.: 10/280,410

(22) Filed: Oct. 25, 2002

(51) Int. Cl. B42F 21/00

(52) U.S. Cl. 283/36

(57) ABSTRACT

The invention is a method of obtaining a gift list, and a system for doing the same. The method includes the steps of folding an outer card along a fold line, and removably attaching an inner card to the outer card so that the outer card substantially envelops the inner card, thereby forming a pair. The method also includes the steps of completing the gift chart, folding the inner card along a crease, thereby substantially concealing the gift chart when the inner card is in a folded position, and returning the inner card to the sender. The system includes a greeting card and an inner card removably attached thereto. A sender sends the system to the recipient, who returns the inner card to the sender after completing the gift list chart.

### SUMMARY OF THE INVENTION

The invention is a method of obtaining a gift wish list from an intended recipient of a gift; the invention also includes a system for obtaining a gift wish list.

The inventive method includes the steps of folding an outer card, such as a greeting card, along a fold line. Additionally, the method includes removably attaching an inner card to the outer card so that the outer card substantially envelops the inner card, and printing a gift list chart on a first face of the inner card. The method further comprises the step of sending the cards to a recipient. The method also includes removing the inner card from the outer card, and completing the gift chart, and folding the inner card along a crease. The gift chart will be substantially concealed when the inner card is in a folded position. Finally, the method includes the step of returning the inner card to the sender.

The inner card may be sealed in the folded position. In order to accomplish this, a sticker may be placed on the first face, near a first edge of the inner card. The sticker may be extended over the first edge and over a second edge of the inner card, thereby holding the edges together when the inner card is in the folded position.

Alternatively, the method may include the step of positioning an adhesive strip on the first face of the inner card so that, when folded, the adhesive strip maintains the inner card in the folded position. Moreover, the sender's address may be printed on a second face of the inner card, enabling the inner card to be used as a return mailer.

As noted above, the method includes the steps of removably attaching the inner card to the outer card. This attachment step may be accomplished by perforatedly attaching the outer card to the inner card. This perforated attachment may be positioned at the intersection of the fold of the outer card and the crease of the inner card. Alternatively, an edge of the greeting card may be perforatedly attached to an edge of the inner card. In yet another embodiment, the inner card may be attached to the outer card by an adhesive, such as a dollop of rubber cement or glue.

The method may include placing both the outer card and inner card together in an envelope in order to send—preferably, by mail—the system to a recipient. Additionally, the method may include the step of returning the inner card to the sender. Consequently, the method should include the step of configuring the inner card so that it would conform to postal requirements regarding its size and shape. In order to ease the step of returning the inner card to the sender, postage may be affixed to the inner card.

The invention also includes a system for sending a greeting card and obtaining a wish list from its recipient. The system includes a greeting card and a return card removably attached to the greeting card, thereby forming a pair. The return card has a first side bearing a gift list chart for the recipient to complete, and a second side facing opposite the first side. A crease enables the return card to be folded so that the first side is substantially concealed when in a folded position. The system also includes a means for holding the inner card in the folded position. This combination of inventive features enables a sender to send the pair to the recipient, who in turn returns the return card to the sender after completing the gift list chart.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective view showing a first embodiment of the system for obtaining a gift wish list, according to the principles of the invention.

FIG. 2 is an exploded view showing a second embodiment of the system for obtaining a gift wish list.

FIG. 3 is a perspective view showing another embodiment of the system for obtaining a gift wish list.

FIG. 4 shows the inner face of the inner, return card.

### DETAILED DESCRIPTION OF THE PREFERRED EMBODIMENTS

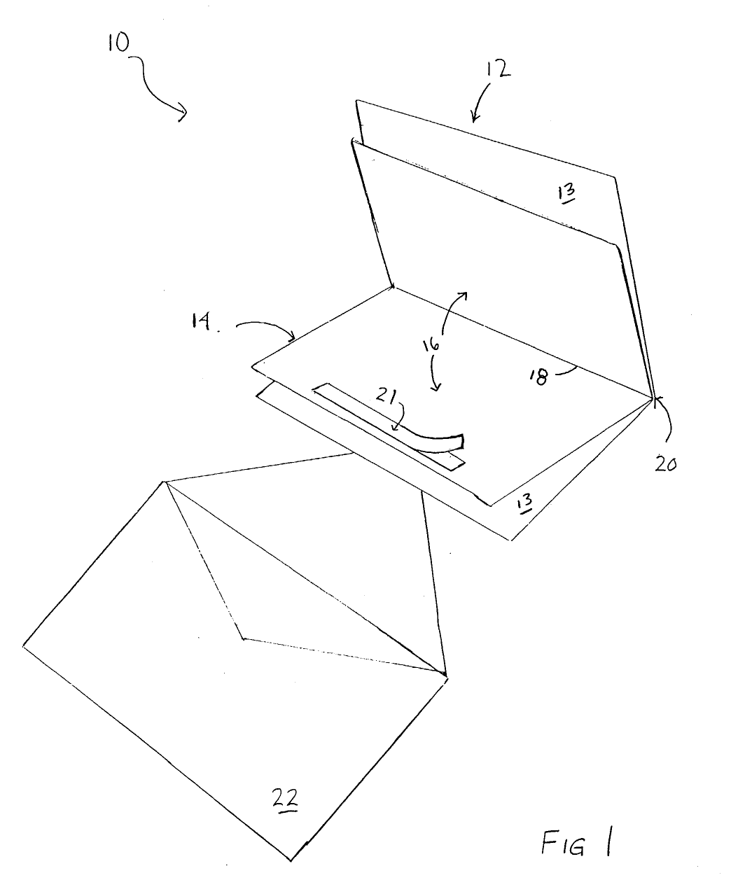

FIG. 1 shows a perspective view of a first embodiment of the system 10. The system 10 comprises an outer card 12, such as a greeting card. Generally, the outer card 12 has an inner face 13 which is concealed when the outer card 12 is folded along its fold line 20. An inner card 14 having a first side 16 is positioned and configured to engage the outer card 12.

As shown in FIG. 1, the inner card 14 engages the outer card 12 by placing the crease 18 of the inner card 14 to engage the fold line 20 of the outer card 12. In this embodiment, the crease 18 of the inner card 14 is attached the fold line 20 of outer card 12. The attachment may be by any known means, such as a perforated attachment, or by any known adhesive, such as tape or a dollop of rubber cement, by any known attachment means allowing removal of the inner card 14 from the outer card 12. For example, a piece of double sided tape may be affixed to the inner face 13 of the outer card 12 to maintain the inner card 14 in contact with the outer card 12 as the cards 12, 14 are folded along their respective folds 20, 18.

Still referring to FIG. 1, the outer card 12 may fold such that the inner card 14 is substantially enveloped within the outer card 12 when in its folded position. Of course, such an arrangement is not mandatory. In one embodiment, the outer card 12 may be a single sheet of stock, for example, without a fold. In this embodiment, the inner card 14 may also comprise a single sheet of card stock adhered to the outer card. In this alternative embodiment, which is admittedly not shown in FIG. 1, the inner card 14 would be similar to a postcard.

Still referring to FIG. 1, this preferred embodiment shows the inner card 14 to bear a sealing means, such as an adhesive strip 21 located adjacent an edge of the inner face 16 of the inner card 14. As shown, the adhesive strip 21 has a removable tape, enabling a sender to selectively remove the tape and thereby enabling the sender to seal the inner card 14. The system may also include an envelope 22 configured to encase the outer card 12 and inner card 14.

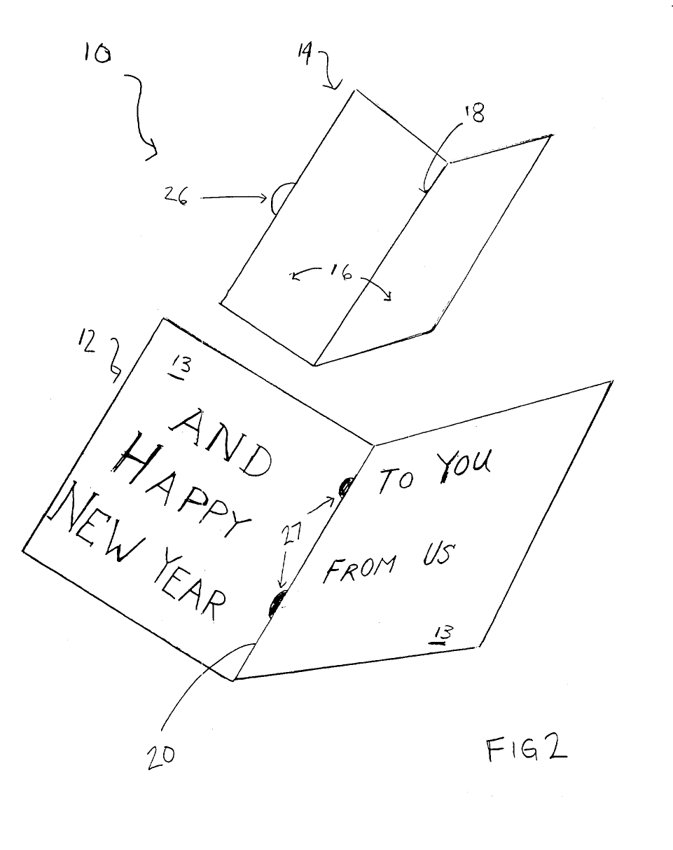

FIG. 2 shows an exploded view of an alternate embodiment of the system 10. As shown in FIG. 2, the outer card 12 has a fold 20 that substantially halves the card 12. The inner card 14 has a crease 18 enabling one to fold the inner card 14 so that its inner face 16 is substantially concealed when the inner card 14 is in the folded position. Preferably, the outer card 12 substantially envelopes the inner card 14 when both cards 12, 14 are in the folded position.

Still referring to FIG. 2, an adhesive 27 is positioned between the outer card 12 and inner card 14. As shown, the adhesive 27 is positioned adjacent the fold 20. The crease 18 on the inner card 14 may then engage the fold 20 of the outer card 12 when the cards 12,14 are in the folded position.

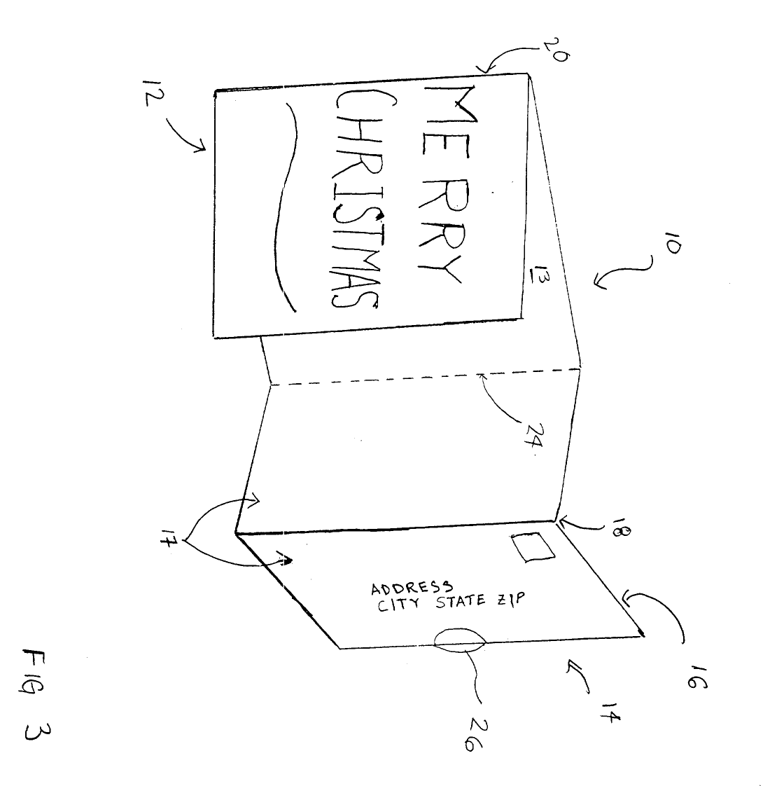

Still referring to FIG. 2, the adhesive 27 may be any known adhesive, such as rubber cement or dual-sided tape. Even though FIG. 2 shows the adhesive 27 positioned along the fold 20, such a configuration is not required. The adhesive should be positioned so as not to damage any of the inner face 13 of the outer card 12, or the outer face 17 (not visible in FIG. 2, but shown in FIG. 3) of the inner card when the cards 12,14 are detached from one another. In that regard, non-permanent type adhesives are preferred.

FIG. 3 shows an alternate embodiment of the system 10. In this embodiment, the outer card 12, shown to be a typical greeting card, is attached to the inner card 14 at a common edge 24. In order to facilitate separation of the outer card 12 from the inner card 14, the common edge 24 may be perforated. Alternatively, other methods of attachment may be used.

As shown in FIG. 3, the inner card 14 has an inner face 16, and an outer face 17. The outer face 17 of the inner card 14 bears a return address, and may also bear postage enabling the recipient of the system 10 to detach the inner card 14 from the outer card 12 and deposit inner card in the mail.

In the embodiment shown in FIG. 3, the inner card 14 bears a sticker 26 positioned adjacent a terminal edge of the inner card 14. The sticker is positioned in order to maintain the inner card 14 in a folded position, wherein the inner faces contact one another after folding the inner card along its crease 18. Any known means may be used to hold the inner card 14 in a folded position, such as a staple, for example.

FIG. 3 shows the outer card 12 attached to the inner card 14 at a perforated common edge 24 that is distal the fold 20. However, this configuration is not necessary, as the inner card 14 may be attached to the outer card 12 at any of its edges, including edges proximate the fold 20.

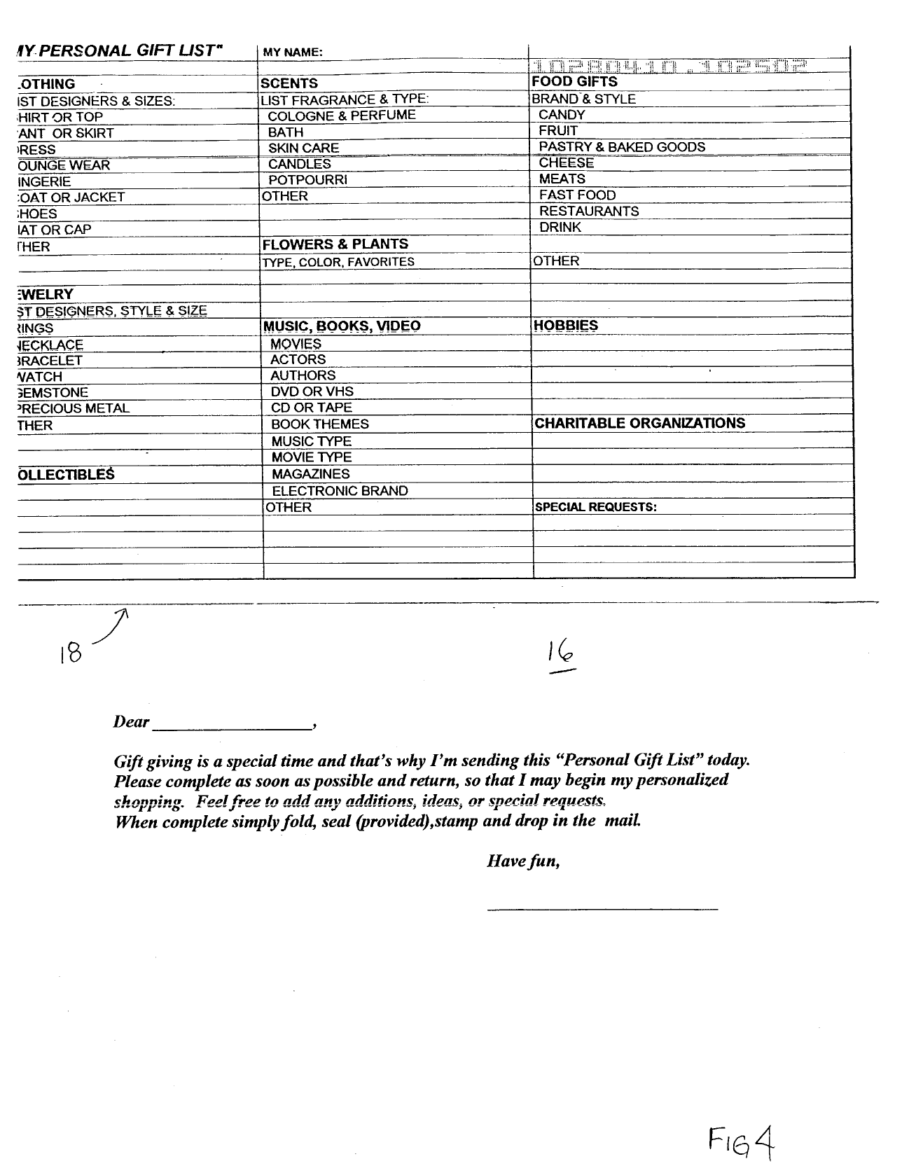

FIG. 4 shows one example of a personal gift list chart that may be imprinted on the first face 16. Of course, the personal gift list chart may be amended to accommodate the personal tastes of the sender, or the personal tastes or desires of the recipient. The personal gift list chart shown imprinted on the face 16 is set forth for illustrative proposes only, and should not be construed to limit the scope of the claims.

Still referring to FIG. 4, the inner card 14 should be configured such that its shape is symmetric about crease 18, so when the inner card 14 is folded along the crease 18, the first face 16 becomes substantially concealed. Optionally, one may configure the size of the inner card such that when folded along crease 18, the inner card is a size suitable for mailing, such as the size of standard business envelope.

Although the present invention has been described and illustrated in detail, it is to be clearly understood that the same is by way of illustration and example only, and is not to be taken by way of limitation. The spirit and scope of the present invention are to be limited only by the terms of the appended claims.

I claim:

1. A method of obtaining a gift wish list, the method comprising the steps of:
folding an outer card along a fold line;
removably attaching an inner card to the outer card;
substantially enveloping the inner card with the outer card, thereby forming a pair;
printing a gift list chart on a first face of the inner card;
sending the pair from a sender to a recipient;
removing the inner card from the outer card;
completing the gift chart;
folding the inner card along a crease, thereby substantially concealing the gift chart when the inner card is in a folded position; and
returning the inner card to the sender.

2. The method of claim 1, further comprising the step of sealing the inner card in the folded position.

3. The method of claim 2, wherein the sealing step includes the steps of
mounting a sticker on the first face and adjacent a first edge of the inner card; and
extending the sticker from the first edge to engage a second edge of the inner card,
wherein
the first edge and second edge are held together by the sticker when the inner card is in the folded position.

4. The method of claim 1, wherein the inner card further includes a means for holding the inner card in the folded position.

5. The method of claim 4, wherein the holding means includes an adhesive strip positioned on the first face of the inner card.

6. The method of claim 1, further comprising the step of affixing the sender's address on a second face of the inner card.

7. The method of claim 1, wherein the step of removably attaching the inner card to the outer card is accomplished by at least one of the following:
perforatedly attaching the outer card to the inner card; or
positioning an adhesive between the inner card an outer card.

8. The method of claim 1, further comprising the step of perforatedly attaching an edge of the outer card to an edge of the inner card.

9. The method of claim 1, further comprising the step of mailing the pair from the sender to the recipient.

10. The method of claim 1, further comprising the step of attaching postage to the inner card.

11. The method of claim 1, further comprising the step of placing the pair within an envelope.

12. A system for obtaining a wish list from a recipient of a greeting card, the system comprising:
a return card removably attached to the greeting card, the return card configured to be substantially enveloped within the greeting card when the greeting card is in a folded position, thereby forming a pair, the return card having
a first side bearing a gift list chart for the recipient to complete;
a second side facing opposite the first side;
a crease enabling the return card to be folded so that the gift list chart is substantially concealed when in a folded position; and
a means for holding the return card in the folded position;
WHEREIN, the recipient completes the gift list chart, folds the return card along its crease, and returns the return card to the sender.

13. The system of claim 12, wherein the return card is removably attached to the greeting card by at least one of
a perforated attachment; or,
an adhesive positioned between the outer card and return card.

14. The system of claim 12, further comprising at least one dollop of rubber cement positioned between the return card and outer card.

15. The system of claim 12, further comprising
a fold line on the greeting card; and wherein,
the fold line is perforatedly attached to the crease.

16. The system of claim 12, further comprising an envelope configured to encase the pair.

17. The system as in claim 12 wherein the means for maintaining the return card in a folded position includes a sticker positioned adjacent a first edge of the return card.

18. The system as in claim 17, wherein the sticker is configured to extend from the first edge and engage a second edge of the return card when in the folded position.

19. The system as in claim 12, wherein the holding means includes an adhesive strip positioned adjacent an edge of the return card and the first face of the return card.

20. A system for obtaining a gift wish list, the system comprising:
a greeting card having a fold;
a return card removably attached to the greeting card and configured to be substantially enveloped within the greeting card when the greeting card is in a folded position, thereby forming a pair, the return card having
a first side bearing a gift list chart for the recipient to complete;
a second side facing opposite the first side;
a crease enabling the return card to be folded so that the gift list chart is substantially concealed when in a folded position;
a return mailing address affixed to the second side of the return card;
a sticker positioned adjacent an edge of the return card, the sticker configured and positioned to hold the card in a folded position;
WHEREIN, the greeting card is removably attached to the return card by at least one of the following:
a perforated attachment connecting an edge of the greeting card to an edge of the return card; or
a perforated attachment connecting the fold to the crease; or,
an adhesive positioned between the fold and the crease; or,
an adhesive positioned between the return card and greeting card.
